(19) United States
(12) Patent Application Publication
(10) Pub. No.: US 2026/0049211 A1
(43) Pub. Date: Feb. 19, 2026

(54) "FISHEYE"-FREE PERFLUOROPOLYETHER ELASTOMER COMPOSITION AND PREPARATION METHOD THEREFOR

(71) Applicant: SHANGHAI MORISEAL NEW MATERIAL TECHNOLOGY CO., LTD., Shanghai (CN)

(72) Inventors: Jiazhuang SHANG, Shanghai (CN); Guohua XIU, Shanghai (CN)

(73) Assignee: SHANGHAI MORISEAL NEW MATERIAL TECHNOLOGY CO., LTD., Shanghai (CN)

(21) Appl. No.: 19/102,405

(22) PCT Filed: Dec. 26, 2023
(86) PCT No.: PCT/CN2023/141979

§ 371 Date: Feb. 9, 2025

(30) Foreign Application Priority Data
Jul. 13, 2023 (CN) 202310854408.4

(51) Int. Cl. C08L 27/18; C08J 3/16; C08J 3/24

(52) U.S. Cl. CPC C08L 27/18; C08J 3/16; C08J 3/24; C08J 2327/18; C08J 2427/18; C08L 2205/025; C08L 2312/00

(57) ABSTRACT

Provided in the present application are a “fisheye”-free perfluoropolyether elastomer composition and a preparation method therefor, which are applied to the field of perfluoropolyether elastomers. The preparation method comprises: S1, mixing a PFA emulsion containing a PTFE core and a perfluoropolyether elastomer emulsion containing a PTFE core, the PFA emulsion being a copolymer of TFE (90-99 wt %) and PPVE (1-10 wt %); S2, adding a precipitant to the mixed emulsion for coprecipitation, washing same, and performing dehydration and drying to obtain a perfluoropolyether elastomer powder; S3, adding a vulcanizer and/or a crosslinking accelerator to the perfluoropolyether elastomer powder, and performing tight-milling mixing, compression molding and secondary vulcanization to obtain the perfluoropolyether elastomer composition. The method uses coprecipitation of the perfluoropolyether elastomer and the PFA emulsion having the core-shell structures to improve the overall compatibility of the emulsion; in addition, PTFE being dispersed in the perfluoropolyether elastomer and the PFA emulsion improves the performance of the perfluoropolyether elastomer composition.

### TECHNICAL FIELD

The invention relates to the field of perfluoroelastomers, in particular to a “fisheye”-free perfluoroelastomer composition and a preparation method therefor.

### BACKGROUND ART

Fluorine is known to be the most electronegative of all chemical elements and the element with the highest degree of oxidation. The hydrogen atoms in the main chain or side chain of perfluoroelastomer are all replaced by fluorine atoms. Therefore, perfluoroelastomer has high chemical stability, is difficult to be oxidized and decomposed, and shows the best medium resistance of all elastomers. However, its physical properties such as compression set and other properties are poor, so that appropriate crosslinking and filling systems must be introduced.

Polytetrafluoroethylene PTFE is widely used as reinforcing filler for fluororubber. After the reinforcing filler is added, the mechanical properties, modulus, hardness and the like of the perfluoroelastomer composition increase. However, in the subsequent processing, due to the existence of shear and temperature change procedure, after introduction of the reinforcing filler into highly clean perfluoroelastomer, some “fisheye” s (crystal spots) will be generated, which will affect the quality of its products and reduce the cleanliness.

“fisheye” s can be divided into impurity “fisheye” s, “fisheye” s caused by bubbles and “fisheye” s caused by poor compatibility between filler and perfluoroelastomer, and the like. The main causes are related to the quality of PTFE and additives, processing formulation and processing technology, and the like. Impurity “fisheye” s and “fisheye” s caused by bubbles can be solved by process quality control. However, there is no good solution to the “fisheye” problem caused by poor compatibility between PTFE and perfluoroelastomer.

PTFE filler is generally physically mixed and is in a dispersed phase, and perfluoroelastomer is in a continuous phase. Due to shearing force in processing, some PTPE particles are thinned or filamentized. Compared to the bulk material, the chemical potential of the individual tiny particulate increases and the melting point decreases. In the subsequent sulfurization, the PTFE particles, which are thinned or filamentized, are melted and scorched first, then produced “fisheye” s, resulting in the scrapping of the finished product.

### SUMMARY OF THE INVENTION

In view of this, the invention provides a preparation method of a “fisheye”-free perfluoroelastomer composition and the product thereof, thereby reducing the “fisheye” phenomenon of the perfluoroelastomer and increasing the yield of the perfluoroelastomer composition.

The embodiment of the specification provides the following technical solution: A preparation method of a “fisheye”-free perfluoroelastomer composition comprises:
S1, Mixing a PFA emulsion containing a PTFE core and a perfluoroelastomer emulsion containing a PTFE core, the PFA emulsion being a copolymer of TFE (90-99 wt %) and PPVE (1-10 wt %);
S2, Adding a precipitant to the mixed emulsion for co-precipitation, washing same, performing dehydration and drying to obtain a perfluoroelastomer powder;
S3, Adding a vulcanizer and/or a crosslinking accelerator to the perfluoroelastomer powder, and performing mixing and thin-passing, compression molding, and secondary vulcanization to obtain the perfluoroelastomer composition.

Optionally, the PFA emulsion containing a PTFE core and the perfluoroelastomer emulsion containing a PTFE core are respectively synthesized by an emulsion polymerization method.

Optionally, the precipitant is a water-soluble organic solvent.

Optionally, the water-soluble organic solvent comprises at least one of acetone, ethanol or tetrahydrofuran.

Optionally, the mass ratio of the PFA emulsion containing a PTFE core to the perfluoroelastomer emulsion containing a PTFE core is 1:5-20.

Optionally, in S2, the drying temperature is not higher than 120° C.

Optionally, in the PFA emulsion containing a PTFE core, the mass ratio of PTFE to PFA is 1:1-10, and in the perfluoroelastomer emulsion containing a PTFE core, the mass ratio of PTFE to the perfluoroelastomer is 1:2-10.

Optionally, the average particle size ratio of the PFA emulsion containing a PTFE core to the perfluoroelastomer emulsion containing a PTFE core is 1:1-10.

Optionally, the vulcanizer is di-tert-butyl isopropyl benzene peroxide (BIPB) or 2,5-dimethyl-2,5-di-(tert-butylperoxy) hexane (Bis-25), and the crosslinking accelerator is triallyl isocyanurate (TAIC).

Optionally, the vulcanization site of the perfluoroelastomer containing a PTFE core contains iodine and/or bromine.

The embodiment of the present application also provides a “fisheye”-free perfluoroelastomer composition, which is prepared by the preparation method described above.

Compared with the prior art, the beneficial effects of at least one of the above-mentioned technical solutions in the embodiment of the specification at least include: In this application, the method of co-precipitation of perfluoroelastomer emulsion and PFA emulsion with core-shell structure is used to co-polymerize with PPVE and TFE to make PFA a meltable PTFE, that is, the flexibility of PFA polymer chain is improved by co-polymerization PPVE, the crystallinity of PFA is reduced, the compatibility of PFA containing PTFE core and perfluoroelastomer containing PTFE core is improved, the “fisheye” s generation of perfluoroelastomer composition is inhibited, and the performance of perfluoroelastomer composition is improved.

### BRIEF DESCRIPTION OF DRAWING

In order to explain the technical solution of the embodiment of the application more clearly, the following will briefly introduce the drawings needed in the embodiment. Obviously, the drawings in the following description are only some embodiments of the application. For those skilled in the art, other drawings can be obtained according to these drawings without inventive labor.

FIG. 1 is a schematic flow chart of the preparation method of the “fisheye”-free perfluoroelastomer composition.

### DETAILED DESCRIPTION OF THE PREFERRED EMBODIMENT

Hereinafter, embodiments of the present application will be described in detail with reference to the accompanying drawing.

The embodiments of the present application are described below by specific examples, and other advantages and effects of the application can be easily understood by those skilled in the art from the disclosure of the present specification. Obviously, the described embodiments are only some embodiments of the present application, not all embodiments. This application can also be implemented or applied through different specific embodiments of in addition. The details in this specification can also be modified or changed based on different viewpoints and applications without departing from the spirit of this application. It should be noted that the following embodiments and the features in the embodiments can be combined with each other without conflict. Based on the embodiments in this application, all other embodiments obtained by ordinary technicians in this field without inventive labor are within the scope of protection in this application.

It is to be noted that various aspects of embodiments within the scope of the appended claims are described below. It should be apparent that the aspects described herein may be embodied in a wide variety of forms, and any specific structures and/or functions described herein are merely illustrative. Based on this application, those skilled in the art will appreciate that one aspect described herein may be implemented independently of any other aspect, and two or more of these aspects may be combined in various ways. For example, devices and/or practical methods may be implemented using any number and aspects set forth herein. In addition, the apparatus may be implemented and/or the method practiced using other structures and/or functionality than one or more of the aspects set forth herein.

In addition, in the following description, specific details are provided to facilitate a thorough understanding of the examples. However, one skilled in the art will understand that the present invention may be practiced without these specific details.

Polytetrafluoroethylene PTFE is widely used as reinforcing filler for fluororubber. After the reinforcing filler is added, the mechanical properties, modulus, hardness and the like of the perfluoroelastomer composition increase. However, in the subsequent processing, due to the existence of shear and temperature change procedure, after introduction of the reinforcing filler into highly clean perfluoroelastomer, some “fisheye” s (crystal spots) will be generated, which will affect the quality of its products and reduce the cleanliness.

“fisheye” s can be divided into impurity “fisheye” s, “fisheye” s caused by bubbles and “fisheye” s caused by poor compatibility between filler and perfluoroelastomer, and the like. The main causes are related to the quality of PTFE and additives, processing formulation and processing technology, and the like. Impurity “fisheye” s and “fisheye” s caused by bubbles can be solved by process quality control. However, there is no good solution to the “fisheye” problem caused by poor compatibility between PTFE and perfluoroelastomer.

PTFE filler is generally physically mixed and is in a dispersed phase, and perfluoroelastomer is in a continuous phase. Due to shearing force in processing, some PTFE particles are thinned or filamentized. Compared to the bulk material, the chemical potential of the individual tiny particulate increases and the melting point decreases. In the subsequent sulfurization, the PTFE particles, which are thinned or filamentized, are melted and scorched first, then produced “fisheye” s, resulting in the scrapping of the finished product.

Due to the high viscosity of perfluoroelastomers, it is easy to agglomerate due to uneven dispersion of emulsions and high drying temperatures, and once agglomerates, it is difficult to remove the moisture and volatiles inside. In the invention, a core-shell structure is adopted to respectively synthesize a PFA emulsion containing a PTFE core and a perfluoroelastomer emulsion containing a PTFE core, and the two emulsions are mixed, co-precipitated, washed, centrifugally dehydrated and dried. PFA is a processable PTFE containing less than 10 wt % of PPVE (perfluoropropyl vinyl ether), while the perfluoroelastomer contains about 30-50 wt % of PPVE, so that the two are compatible. In addition, the co-precipitation is uniformly dispersed, and the plasticity is enhanced to facilitate drying.

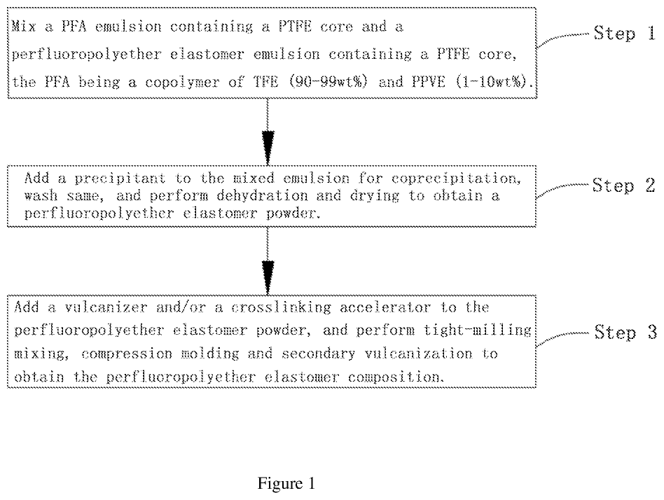

Based on this, the embodiment of the specification provides a preparation method of a “fisheye”-free perfluoroelastomer composition, as shown in FIG. 1, comprises:

Step 1, Mixing a PFA emulsion containing a PTFE core and a perfluoroelastomer emulsion containing a PTFE core, the PFA emulsion being a co-polymer of TFE (90-99 wt %) and PPVE (1-10 wt %);

Step 2, Adding a precipitant to the mixed emulsion for co-precipitation, washing same, performing dehydration and drying to obtain a perfluoroelastomer powder;

Step 3, Adding a vulcanizer and/or a crosslinking accelerator to the perfluoroelastomer powder, and performing mixing and thin-passing, compression molding, and secondary vulcanization to obtain the perfluoroelastomer composition.

In Step 1, the mass ratio of the PFA emulsion containing a PTFE core to the perfluoroelastomer emulsion containing a PTFE core is 1:5-20, and the average particle size ratio of the PFA emulsion containing a PTFE core to the perfluoroelastomer emulsion containing a PTFE core is 1:1-10, and the PFA emulsion containing a PTFE core and the perfluoroelastomer emulsion containing a PTFE core are respectively synthesized by an emulsion polymerization method.

In Step 2, the precipitant is a water-soluble organic solvent. The water-soluble organic solvent can be acetone, ethanol or tetrahydrofuran, and the drying temperature is not higher than 120° C.

In Step 3, the vulcanizer is BIPB or Bis-25, and the crosslinking accelerator is TAIC. The vulcanization site of the perfluoroelastomer containing a PTFE core contains iodine and/or bromine, and fluoroalkyl iodide is used as chain transfer agent, and the crosslinking agent as used is BIPB or Bis-25, wherein BIPB is di-tert-butyl isopropyl benzene peroxide (CAS #: 25155-25-3), Bis-25 is 2,5-dimethyl-2,5-di-(tert-butylperoxy) hexane (CAS #: 78-63-7), and the crosslinking accelerator is TAIC, that is triallyl isocyanurate (CAS #: 1025-15-6).

In Step 3, the molding conditions are pressure of 8-12 MPa, temperature of 160-175° C., and time of 5-16 min. The secondary vulcanization conditions are temperature of 200-220° C. and time of 10-24 hr.

PFA (Polyfluoroalkoxy) is a tetrafluoroethylene-perfluoroalkoxy vinyl ether copolymer. PFA resin is a melt processable fluoroplastic with similar chemical properties to FEP and PTFE. However, FEP can only be used at a temperature of below 200° C., while PTFE cannot be injection molded. The PFA composition contains 1 wt % to 10 wt % of perfluoropropyl vinyl ether (PPVE), which significantly improves the pliability of PFA polymer chain, reduces the crystallinity of PFA, and enables PFA to show good thermoplasticity.

### Example 1

Step 1, 80 g of PFA emulsion containing a PTFE core and 1000 g of perfluoroelastomer emulsion containing a PTFE core were mixed. The average particle size ratio of the PFA emulsion containing a PTFE core and the perfluoroelastomer emulsion containing a PTFE core was about 1:1. The PFA emulsion containing a PTFE core and the perfluoroelastomer emulsion containing a PTFE core were respectively synthesized by an emulsion polymerization method.

In the PFA emulsion containing a PTFE core, the mass ratio of PTFE to PFA was 1:10. In the perfluoroelastomer emulsion containing a PTFE core, the mass ratio of PTFE to the perfluoroelastomer was 1:10. The PFA emulsion was a co-polymer of TFE (90-99 wt %) and PPVE (1-10 wt %).
Step 2, The mixed emulsion was added with acetone for co-precipitation, washed, dehydrated and dried at 120° C. to obtain a perfluoroelastomer powder;
Step 3, The perfluoroelastomer powder was added with 10 g of vulcanizer BIPB and 20g of crosslinking accelerator TAIC, mixing and thin-passing, compression molded, and subjected to secondary vulcanization to obtain the perfluoroelastomer composition. The molding conditions were: pressure of 8 MPa, temperature of 160° C., time of 5 min. The secondary vulcanization conditions were temperature of 200° C. and time of 10 hr.

### Example 2

Step 1, 100 g of PFA emulsion containing a PTFE core and 1000 g of perfluoroelastomer emulsion containing a PTFE core were mixed. The average particle size ratio of the PFA emulsion containing a PTFE core and the perfluoroelastomer emulsion containing a PTFE core was 1:5. The PFA emulsion containing a PTFE core and the perfluoroelastomer emulsion containing a PTFE core were respectively synthesized by an emulsion polymerization method.

In the PFA emulsion containing a PTFE core, the mass ratio of PTFE to PFA was 1:5. In the perfluoroelastomer emulsion containing a PTFE core, the mass ratio of PTFE to the perfluoroelastomer was 1:5. The PFA emulsion was a copolymer of TFE (90-99 wt %) and PPVE (1-10 wt %).

Step 2, The mixed emulsion was added with ethanol for coprecipitation, washed, dehydrated and dried at 120° C. to obtain a perfluoroelastomer powder;
Step 3, The perfluoroelastomer powder was added with 10 g of vulcanizer BIPB and 20 g of crosslinking accelerator TAIC, mixing and thin passing, compression molded, and subjected to secondary vulcanization to obtain the perfluoroelastomer composition. The molding conditions were: pressure of 10 MPa, temperature of 170° C., time of 10 min. The secondary vulcanization conditions were temperature of 210° C. and time of 15 hr.

### Example 3

Step 1, 50 g of PFA emulsion containing a PTFE core and 1000 g of perfluoroelastomer emulsion containing a PTFE core were mixed. The average particle size ratio of the PFA emulsion containing a PTFE core and the perfluoroelastomer emulsion containing a PTFE core was 1:10. The PFA emulsion containing a PTFE core and the perfluoroelastomer emulsion containing a PTFE core were respectively synthesized by an emulsion polymerization method.

In the PFA emulsion containing a PTFE core, the mass ratio of PTFE to PFA was 1:1. In the perfluoroelastomer emulsion containing a PTFE core, the mass ratio of PTFE to the perfluoroelastomer was 1:2. The PFA emulsion was a copolymer of TFE (90-99 wt %) and PPVE (1-10 wt %).
Step 2, The mixed emulsion was added with acetone for co-precipitation, washed, dehydrated and dried at 120° C. to obtain a perfluoroelastomer powder;
Step 3, The perfluoroelastomer powder was added with 10 g of vulcanizer Bis-25 and 20 g of crosslinking accelerator TAIC, mixing and thin passing, compression molded, and subjected to secondary vulcanization to obtain the perfluoroelastomer composition. The molding conditions were: pressure of 12 MPa, temperature of 170° C., time of 15 min. The secondary vulcanization conditions were temperature of 220° C. and time of 24 hr.

### Example 4

Step 1, 200 g of PFA emulsion containing a PTFE core and 1000 g of perfluoroelastomer emulsion containing a PTFE core were mixed. The average particle size ratio of the PFA emulsion containing a PTFE core and the perfluoroelastomer emulsion containing a PTFE core was 1:10. The PFA emulsion containing a PTFE core and the perfluoroelastomer emulsion containing a PTFE core were respectively synthesized by an emulsion polymerization method.

In the PFA emulsion containing a PTFE core, the mass ratio of PTFE to PFA was 1:3. In the perfluoroelastomer emulsion containing a PTFE core, the mass ratio of PTFE to the perfluoroelastomer was 1:2. The PFA emulsion was a co-polymer of TFE (90-99 wt %) and PPVE (1-10 wt %).
Step 2, The mixed emulsion was added with acetone for co-precipitation, washed, dehydrated and dried at 120° C. to obtain a perfluoroelastomer powder;
Step 3, The perfluoroelastomer powder was added with 20 g of vulcanizer Bis-25 and 40 g of crosslinking accelerator TAIC, mixing and thin-passing, compression molded, and subjected to secondary vulcanization to obtain the perfluoroelastomer composition. The molding conditions were: pressure of 12 MPa, temperature of 175° C., time of 16 min. The secondary vulcanization conditions were temperature of 220° C. and time of 24 hr.

### Example 5

Step 1, 100 g of PFA emulsion containing a PTFE core and 1000 g of perfluoroelastomer emulsion containing a PTFE core were mixed. The average particle size ratio of the PFA emulsion containing a PTFE core and the perfluoroelastomer emulsion containing a PTFE core was 1:5. The PFA emulsion containing a PTFE core and the perfluoroelastomer emulsion containing a PTFE core were respectively synthesized by an emulsion polymerization method.

In the PFA emulsion containing a PTFE core, the mass ratio of PTFE to PFA was 1:5. In the perfluoroelastomer emulsion containing a PTFE core, the mass ratio of PTFE to the perfluoroelastomer was 1:5. The PFA emulsion was a co-polymer of TFE (90-99 wt %) and PPVE (1-10 wt %).
Step 2, The mixed emulsion was added with ethanol for co-precipitation, washed, dehydrated and dried at 80° C. to obtain a perfluoroelastomer powder;
Step 3, The perfluoroelastomer powder was added with 10 g of vulcanizer BIPB and 20 g of crosslinking accelerator TAIC, mixing and thin-passing, compression molded, and subjected to secondary vulcanization to obtain the perfluoroelastomer composition. The molding conditions were: pressure of 10 MPa, temperature of 170° C., time of 10 min. The secondary vulcanization conditions were temperature of 210° C. and time of 15 hr.

### Comparative Example 1

150 g of PTFE micro-powder and 1000 g of perfluoroelastomer emulsion were mixed. The mixed emulsion was added with acetone for coprecipitation, washed, dehydrated and dried at a drying temperature of 120° C. to obtain a perfluoroelastomer powder;

The perfluoroelastomer powder was added with 10 g of vulcanizer BIPB and 20 g of crosslinking accelerator TAIC, mixing and thin-passing, compression molded, and subjected to secondary vulcanization to obtain the perfluoroelastomer composition. The molding conditions were: pressure of 12 MPa, temperature of 175° C., time of 16 min. The secondary vulcanization conditions were temperature of 220° C. and time of 24 hr.

### Comparative Example 2

250 g of PTFE microOpowder and 1000 g of perfluoroelastomer emulsion were mixed. The mixed emulsion was added with acetone for co-precipitation, washed, dehydrated and dried at a drying temperature of 120° C. to obtain a perfluoroelastomer powder;
The perfluoroelastomer powder was added with 20 g of vulcanizer BIPB and 40 g of crosslinking accelerator TAIC, tight-milling mixed and compression molded, and subjected to secondary vulcanization to obtain the perfluoroelastomer composition. The molding conditions were: pressure of 12 MPa, temperature of 175° C., time of 16 min. The secondary vulcanization conditions were temperature of 220° C. and time of 24 hr.

TABLE 1
Main Test Results of Examples and Comparative Examples of the Application

| | | | | | | | Comparative | |
|---|---|---|---|---|---|---|---|---|
| Performance | Testing Method | Example | | | | | Example | |
| Parameter | and Standard | 1 | 2 | 3 | 4 | 5 | 1 | 2 |
| Shore | ASTM D2240- | 71 | 72 | 75 | 79 | 75 | 71 | 74 |
| Hardness, | 2004 | | | | | | | |
| HA | | | | | | | | |
| Tensile | ASTMD412- | 16.0 | 17.7 | 18.2 | 18.8 | 17.9 | 15.2 | 16.8 |
| Strength, | 06a | | | | | | | |
| MPa | | | | | | | | |
| Tensile | ASTMD412- | 8.39 | 8.97 | 9.85 | 11.03 | 9.21 | 6.76 | 7.39 |
| Modulus, | 06a | | | | | | | |
| MPa | | | | | | | | |
| Compression | GB/T 1683- | 19 | 16 | 18 | 20 | 16 | 27 | 20 |
| Set, % | 2018 | | | | | | | |

| Appearance | Microscope | “fisheye”-free | Contain |
|---|---|---|---|
| | Observation | | “fisheye” |

Through the comparison in Table 1, it can be seen that the final product of the perfluoroelastomer composition prepared by the method of the application uses the form of a core to add polytetrafluoroethylene in situ during polymerization of the perfluoroelastomer, and the synthesized two emulsions were mixed and co-precipitated, uniformly dispersed and convenient to dry, thus solving the problems that the perfluoroelastomer is sticky at higher temperature, is easy to agglomerate during drying, and is difficult to remove internal moisture and volatiles. The mechanical properties of the perfluoroelastomer composition are increased, and the generation of “fisheye” s in the perfluoroelastomer composition are inhibited, and the performance of the perfluoroelastomer composition is improved.

In this specification, the same and similar parts between various embodiments can be referred to each other. Each embodiment focuses on the differences from other embodiments. In particular, for the embodiment described later, the description is relatively simple, and the relevant parts can be found in the partial description of the previous embodiment.

The above description is only a specific embodiment of the present application, but the scope of protection of the present application is not limited to this. Any changes or substitutions that can easily occur to those skilled in the art within the technical scope disclosed in the present application should be covered within the scope of protection of the present application. Therefore, the scope of protection of this application shall be subject to that of the claims.

1. A preparation method of a “fisheye”-free perfluoroelastomer composition, characterized in that, the method comprises:
S1, Mixing a PFA emulsion containing a PTFE core and a perfluoroelastomer emulsion containing a PTFE core, the PFA emulsion being a copolymer of TFE (90-99 wt %) and PPVE (1-10 wt %), and the mass ratio of the PFA emulsion containing a PTFE core to the perfluoroelastomer emulsion containing a PTFE core is 1:5-20;
S2, Adding a precipitant to the mixed emulsion for co-precipitation, washing same, performing dehydration and drying to obtain a perfluoroelastomer powder;
S3, Adding a vulcanizer and/or a crosslinking accelerator to the perfluoroelastomer powder, and performing mixing and thin-passing, compression molding, and secondary vulcanization to obtain the perfluoroelastomer composition.

2. The preparation method of a “fisheye”-free perfluoroelastomer composition according to claim 1, characterized in that, the PFA emulsion containing a PTFE core and the perfluoroelastomer emulsion containing a PTFE core are respectively synthesized by an emulsion polymerization method.

3. The preparation method of a “fisheye”-free perfluoroelastomer composition according to claim 1, characterized in that, the precipitant is a water-soluble organic solvent.

4. The preparation method of a “fisheye”-free perfluoroelastomer composition according to claim 3, characterized in that, the water-soluble organic solvent comprises at least one of acetone, ethanol or tetrahydrofuran.

5. The preparation method of a “fisheye”-free perfluoroelastomer composition according to claim 1, characterized in that, in S2, the drying temperature is not higher than 120° C.

6. The preparation method of a “fisheye”-free perfluoroelastomer composition according to claim 1, characterized in that, in the PFA emulsion containing a PTFE core, the mass ratio of PTFE to PFA is 1:1-10, and in the perfluoroelastomer emulsion containing a PTFE core, the mass ratio of PTFE to the perfluoroelastomer is 1:2-10.

7. The preparation method of a “fisheye”-free perfluoroelastomer composition according to claim 1, characterized in that, the average particle size ratio of the PFA emulsion containing a PTFE core to the perfluoroelastomer emulsion containing a PTFE core is 1:1-10.

8. The preparation method of a “fisheye”-free perfluoroelastomer composition according to claim 1, characterized in that, the vulcanizer is di-tert-butyl isopropyl benzene peroxide (BIPB) or 2,5-dimethyl-2,5-di-(tert-butylperoxy) hexane (Bis-25), and the crosslinking accelerator is triallyl isocyanurate (TAIC).

9. The preparation method of a “fisheye”-free perfluoroelastomer composition according to claim 1, characterized in that, the vulcanization site of the perfluoroelastomer containing a PTFE core contains iodine and/or bromine.

10. A “fisheye”-free perfluoroelastomer composition characterized in that it is prepared by the method according to claim 1.
